(19) United States
(12) Patent Application Publication
(10) Pub. No.: US 2013/0190057 A1
(43) Pub. Date: Jul. 25, 2013

(54) MOBILE COMMUNICATION DEVICE ENGAGED IN A CALL,

(71) Applicant: Abhishek Sahu, Bangalore (IN)

(72) Inventor: Abhishek Sahu, Bangalore (IN)

(73) Assignee: NOKIA CORPORATION, Espoo (FI)

(21) Appl. No.: 13/809,332

(22) PCT Filed: Jun. 13, 2011
(86) PCT No.: PCT/FI2011/050557

§ 371 Date: Mar. 6, 2013

(30) Foreign Application Priority Data
Jul. 9, 2010 (IN) 1953/CHE/2010

(51) Int. Cl. H04M 1/02

(52) U.S. Cl. CPC H04M 1/0202
USPC 455/566

(57) ABSTRACT

Apparatus is configured to detect a change in position of a mobile communication device from an ear adjacent position to an ear non-adjacent position whilst the device is engaged in a call, and in response to said detection to cause a form for allowing a user to enter a note to be displayed.

### FIELD OF THE INVENTION

This invention relates to operating a mobile communication device engaged in a call.

### BACKGROUND TO THE INVENTION

It is now common for mobile devices such as mobile phones to store various utility applications such as note making applications, calendars and clocks. A user of a mobile device is able to use these applications to create and store messages, reminders, appointments etc. It is also increasingly common for mobile devices to contain sensors such as accelerometers, digital compasses and proximity sensors.

### SUMMARY OF THE INVENTION

A first aspect of the invention provides a method comprising:
in response to detecting a change in position of a mobile communication device from an ear adjacent position to an ear non-adjacent position whilst the device is engaged in a call, displaying a form for allowing a user to enter a note.

The method may further comprise, in response to receiving user content inputs, displaying entered note content in the form. The method may further comprise storing on the device the entered note content in association with a contact participating in the call. Alternatively, the method may further comprise, when the call is ended, saving on the device any currently displayed note content in association with a contact which was a participant in the call.

The method may further comprise, in response to the detected change in position, executing a note taking application to provide the form.

The method may further comprise commencing monitoring signals from one or more of a motion sensor, a positional sensor and an orientation sensor when the device engages in a call.

The method may further comprise comprising using a proximity sensor to detect the change in position.

The method may further comprise responding to the change in position by enabling a speaker mode of the device.

A second aspect of the invention provides apparatus, the apparatus being configured to detect a change in position of a mobile communication device from an ear adjacent position to an ear non-adjacent position whilst the device is engaged in a call, and in response to said detection to cause a form for allowing a user to enter a note to be displayed.

The apparatus may be further configured, in response to receiving user content inputs, to cause entered note content to be displayed in the form. The apparatus may be further configured to store on the device the entered note content in association with a contact participating in the call. Alternatively, the apparatus may be further configured, when the call is ended, to save on the device any currently displayed note content in association with a contact which was a participant in the call.

The apparatus may be further configured, in response to the detected change in position, to execute a note taking application stored on the device in order to provide the form.

The apparatus may be further configured, to activate one or more of a motion sensor, a positional sensor and an orientation sensor when the device engages in a call.

The apparatus may further comprise a proximity sensor configured to detect the change in position.

The apparatus may be further configured to enable a speaker mode of the device in response to the change in position.

A third aspect of the invention provides an apparatus comprising at least one processor; and
at least one memory including computer program code;
   the at least one memory and the computer program code configured to, with the at least one processor, cause the apparatus at least to perform:
in response to detecting a change in position of a mobile communication device from an ear adjacent position to an ear non-adjacent position whilst the device is engaged in a call, displaying a form for allowing a user to enter a note.

A fourth aspect of the invention provides apparatus, the apparatus comprising means for detecting a change in position of a mobile communication device from an ear adjacent position to an ear non-adjacent position whilst the device is engaged in a call, and means responsive to said detection to cause a form for allowing a user to enter a note to be displayed.

A fifth aspect of the invention provides a computer readable medium having stored thereon instructions for causing computing apparatus to perform a method comprising:
in response to detecting a change in position of a mobile communication device from an ear adjacent position to an ear non-adjacent position whilst the device is engaged in a call, displaying a form for allowing a user to enter a note.

A sixth aspect of the invention provides a computer program, optionally stored on a medium, comprising instructions for causing computer apparatus to perform a method as recited above.

### BRIEF DESCRIPTION OF THE DRAWINGS

Embodiments of the present invention will now be described, by way of example only, with reference to the accompanying drawings, in which:

FIG. 1 is a schematic diagram illustrating components of apparatus, in the form of a mobile terminal, embodying aspects of the invention;

FIGS. 2A and 2B are exemplary screenshots of a display provided by the mobile terminal of FIG. 1;

FIG. 3 is a flow chart illustrating certain operation of the FIG. 1 mobile terminal;

FIG. 4 is a flow chart illustrating further operation of the FIG. 1 mobile terminal.

### DETAILED DESCRIPTION OF THE EMBODIMENTS

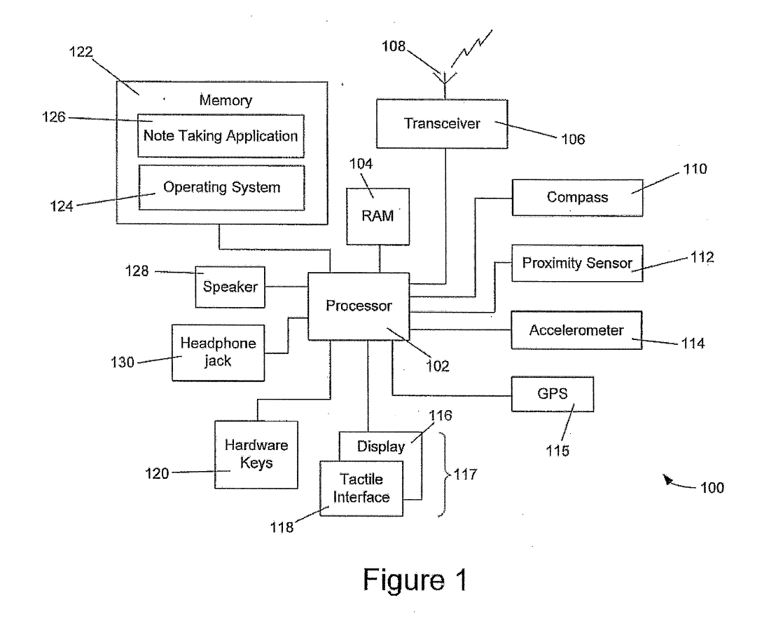

Referring firstly to FIG. 1; a mobile terminal apparatus 100 is shown schematically. The mobile terminal 100 has a processor 102 and a volatile memory such as a random access memory (RAM) 104. The processor 102 is connected to and controls the operation of all of the other components in the mobile terminal 100.

The mobile terminal 100 has a transceiver 106 connected to an antenna 108. These components allow the mobile terminal 100 to communicate over a cellular network (not shown). The mobile terminal 100 may be a mobile phone, smartphone, personal digital assistant (PDA), portable gaming device, portable media player (PMP) or any other mobile device capable of making and/or receiving cellular calls.

The mobile terminal 100 may have a touch sensitive display 117 comprising a display part 116 and a tactile interface 118. The mobile terminal may have hardware keys 120. The mobile terminal 100 also has a number of sensors, which may include a compass 110, a proximity sensor 112, an accelerometer 114 and a positioning receiver, such as a Global Positioning System (GPS) receiver 115.

The mobile terminal 100 also has a memory 122 which may be a non-volatile memory such as read only memory (ROM) a hard disk drive (HDD) or solid state drive (SSD). The memory stores, amongst other things, an operating system 124 and a note taking application 126. The mobile terminal 100 may have a speaker 128 and a headphone jack 130.

The processor 102 and other components may be connected together via a system bus (not shown). The RAM 104 is used by the processor 102 for the temporary storage of data, for instance when controlling the operation of another hardware or software component or moving data between components.

The operating system 124 may comprise a number of software modules that control the basic operations of the mobile terminal 100 and which control the processor 102 to perform those operations and to instruct the other components. The note taking application 126 may be an individual program or a part of the operating system (i.e. a built in program). The note taking application 126 may run on the operating system 124. The note taking application 126 may take the form of a notepad. Software relating to the compass 110, proximity sensor 112, accelerometer 114, GPS receiver 115, touch sensitive display 117, hardware keys 120 and speaker 128 may form part of the operating system 124.

The touch sensitive display 117 and hardware keys 120 facilitate user inputs into the mobile terminal 100. The processor may be configured to receive inputs from the touch sensitive display 117 and hardware keys 120. The inputs are interpreted by the operating system 124, the note taking application 126, another software module or by a combination of these. The note taking application 126 may be configured to recognise inputs in the form of characters (letters, numbers etc.) as well as freeform drawings. In response to receiving inputs, the processor 102 is controlled by the operating system and/or one or more involved applications to act accordingly, for example by controlling the display of content on the display part 116 of the touch sensitive display 117.

The compass 110, proximity sensor 112 and accelerometer 114 may be used to detect and measure relative movement of the mobile terminal 100 and/or detect or infer the environment of the mobile terminal.

The proximity sensor 112 may be able to detect the proximity of any other object to the front face of the mobile terminal. For example, the proximity sensor 112 may use infrared radiation and detect the reflection of this radiation from a nearby object. This detection may be communicated via the processor 102 to the operating system 124, where a determination may be made that the mobile terminal 100 is in proximity to another object. In certain situations, for example when the mobile terminal is being used to make a call, the operating system 124 may control the processor 102 to disable the tactile interface part 118 of the touch sensitive display if it is determined that the mobile terminal 100 is in proximity to another object. In this way, the acting on unintentional inputs can be avoided. Additionally the display part 116 of the touch sensitive display 117 may also be disabled in this situation, such as to reduce power consumption.

The compass 110 may be a solid state compass comprising at least one magnetic field sensor. Compass operating software may form part of the operating system 124 and interprets signals from the compass hardware. The compass operating software may also utilise a positional reading obtained by the GPS receiver 115 to calibrate the compass 110.

The accelerometer 114 may be able to detect an orientation angle with respect to the Earth's surface. The accelerometer 114 may be able to detect acceleration in two or three dimensions. Software associated with the accelerometer 114 may be able to use the detected acceleration and deceleration to estimate an absolute distance travelled by the mobile terminal 100.

In operation a user may make or receive a call on the mobile terminal 100. The transceiver 106 and antenna 108, under instruction from the operating system 124, are controlled to communicate over a cellular network. While engaged in a call, any or all of the compass 110, proximity sensor 112 and accelerometer 114 may monitor the position and movement of the mobile terminal. They may be activated when a call is connected or may already be active. In one example the operating system 124 receives signals from the proximity sensor 112 and determines that the user has moved the mobile terminal to a position adjacent to (or touching) their head. The operating system 124 the controls the processor 102 to disable the tactile interface 118 of the touch sensitive display 117 so that the user does not accidentally cause inputs with their head/ears.

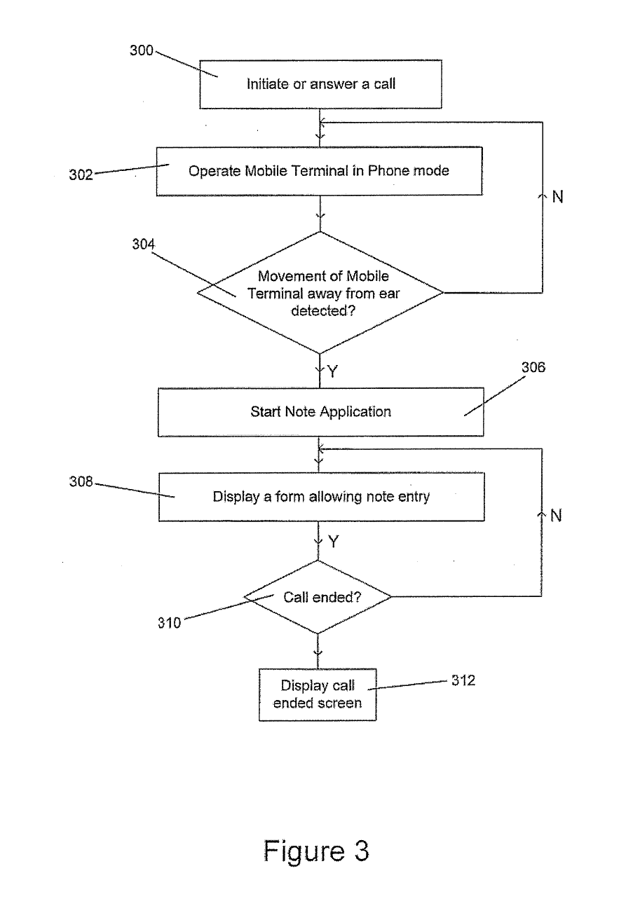

The operating system may also receive signals from the compass 110, proximity sensor 112 and accelerometer 114 from which a change in position of the mobile terminal from an ear adjacent position to an ear non-adjacent position can be determined or inferred. How this is achieved is explained further below with reference to FIG. 3. Detection of such a positional change causes the note taking application 126, stored in the memory 122, to be started, resumed and/or displayed on the display 116.

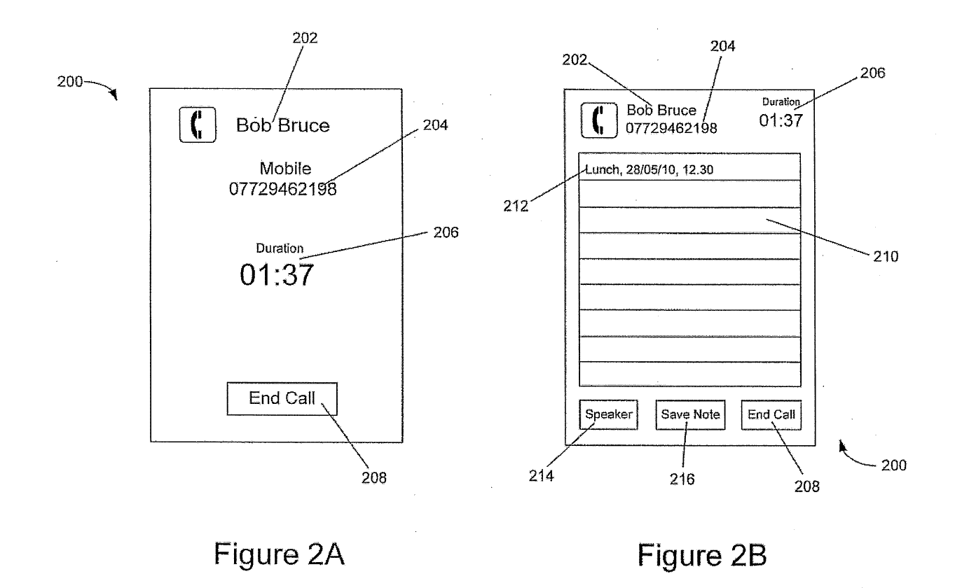

FIGS. 2A and 2B show exemplary screenshots 200 of a display 116 of the mobile terminal 100. FIG. 2A is a screenshot 200 of the mobile terminal display when engaged in a call. The screenshot 200 shows a contact name 202, if known, and a contact number 204 of the other party to the call. If the contact is unknown, the name 202 may be replaced by the text “unknown”, or be left blank. A call duration indication 206 may also be displayed. If the display is a touch sensitive display 117, it may also include software keys, for example, an “end call” software key 208. When a user provides a touch input at this area of the touch sensitive display 117, a signal is sent to the processor 102. In response to this signal, the processor 102 is controlled to terminate the call. The display may also comprise any number of other software keys not depicted here.

FIG. 2A may be the standard display when a call is connected and the user is using the mobile terminal in a “Phone mode”, i.e. with the earpiece placed against their ear. This is hereafter termed an ear adjacent position. The tactile interface 118 and the display 116 may be disabled by the processor 102 under control of the operating system 124 when the mobile terminal is being used in this mode to prevent accidental user input and to reduce power usage.

When the mobile terminal is determined by the operating system 124 to have moved from an ear adjacent position to an ear non-adjacent position, the display may be controlled by the note taking application 126 to change to that of FIG. 2B. The change in position of the mobile terminal 100 causes the operating system 124 to start the note taking application 126, or if it is already running, to resume or prioritise it. The note taking application 126 then instructs the processor 102 to control the display 116 and also interprets inputs received at the processor 102 from the tactile interface 118 and hardware keys 120. In the exemplary screenshot 200 of FIG. 2B, call information such as the contact name 202 and number 204 of the other party to the call, and the call duration 206, which may have occupied the majority of the area of the display, is reduced in size and moved to the top of the display.

In any case, room on the display is made for a note entry form 210 provided by the note taking application 126. The note entry form allows a user to enter text, either by using a software or hardware keyboard or stylus. The note entry form 210 may also allow the user to input a drawing, using a stylus or finger. Inputs from the software or hardware keyboard or stylus are interpreted by the note taking application 126 which instructs the display 116 to display the characters or images. The note taking application 126 may comprise handwriting recognition software able to convert a stylus input into printed text. The note entry form 210 may be lined, as shown in FIG. 2B, may be a blank area, or may have more structured input areas, such as lines or boxes intended for information regarding an activity, time and date. An exemplary text note 212 is shown entered in the note entry form.

The note entry form 210 may occupy the majority of the area of the display, as shown in FIG. 2B. Alternatively, a Qwerty (or other) software keyboard may occupy part of the display if the display is touch sensitive. A number of software keys may be disposed below the note entry form 210. The display may continue to have an “end call” key 208, but may also have a “speaker” key 214 and a “save note” key 216. Selection of the speaker key 214 triggers the operating system 124 to activate the speaker 128 of the mobile terminal 100 in speakerphone mode, so that the voice of the remote participant of the call is amplified and can be heard at a distance from the mobile terminal 100. This feature is useful for when a user of the mobile terminal wishes to continue their conversation while making notes. A user may also connect headphones to the mobile terminal 100 via the headphone jack 130 or via a Bluetooth connection during a call. This allows the user to continue their conversation more discreetly than by using the speaker 128 while still being able to make notes.

Selection of the save note key 216 causes a signal to be sent to the note taking application 216 which causes any notes made in the note entry form 210 to be saved to the memory 122 of the mobile terminal 100. The note may be saved in association with the named contact 202 involved in the call. Once the note has been saved, the note taking application may cause a new, blank note entry form 210 to be displayed. In this way, a user can make several note entries related to the same call and save them separately. Although the keys 208, 214, 216 are described as software keys, they may additionally or alternatively be hardware keys assigned the same functions.

While the note entry form 2.10 is being displayed, if the user moves the mobile terminal from an ear non-adjacent position back to an ear adjacent position, the note taking application 216 may control the display to return to that shown in FIG. 2A. Alternatively the display may remain as shown in FIG. 2B until the call is ended. In either case, the touch sensitive display 117 may be disabled, but the note taking application continues to run. Therefore a user may, if they wish, repeatedly move the mobile terminal 100 away from their ear, make a note and move the mobile terminal back to continue their conversation.

The arrangement of information in FIGS. 2A and 2B should not be construed as limiting, and is chosen merely by way of example.

Referring now to FIG. 3, a flow diagram is shown illustrating an exemplary operation of the mobile terminal 100. At step 300 a call is established. The call may be initiated by the mobile terminal 100 and answered by the other party to the call or initiated by the other party and answered by the mobile terminal 100. At step 302 the mobile terminal 100 is operated in “Phone mode”. This means that it is detected by the operating system 124, for example via signals received from the proximity sensor 112, that the user has positioned the mobile terminal adjacent to their ear. Alternatively, the operating system 124 may merely assume that the user has positioned the mobile terminal adjacent to their ear. In response, the processor 102 may, for example, control the display 116 to provide a screen like that of FIG. 2A, may disable touch inputs to avoid accidental inputs by the user and may disable the display to save power.

At step 304 it is determined whether the mobile terminal has been moved away from a user's ear. This detection may be accomplished in a number of ways, using inputs from any or all of the compass 110, proximity sensor 112 and accelerometer 114, or other sensors. In one embodiment, inputs from the proximity sensor 112 alone are used to detect the change in position. The proximity sensor can be used to detect a relative movement of the terminal with reference to a nearby object, in this case, the user's ear or head. The proximity sensor 112 may emit electromagnetic radiation and detect the amount of reflected radiation. Signals indicating any changes in the amount of reflected radiation are sent via the processor 102 to proximity sensor software running on the operating system 124, where a determination is made that the mobile terminal has been moved away from an object.

The compass 110, in conjunction with compass software running on the operating system 124, can detect the orientation and angular movement of the mobile terminal. When a user moves the mobile terminal 100 from their ear to a position in front of them, such that they are facing the screen, the compass measures a characteristic orientation change comprising an abrupt movement of at least 60 degrees but less than 180 degrees. In one embodiment, such a detection is used as a trigger for running the note taking application 126. However, this trigger has the possibility for false detections to be made, for example if the user abruptly changes their own orientation while holding the mobile terminal to their ear. Outputs from the accelerometer 114 may be used in conjunction with those from the compass 110. The accelerometer 114, in conjunction with accelerometer software running on the operating system 124, may detect the acceleration and deceleration of the mobile terminal 100 as its position is changed and may provide an estimate of the distance travelled by the mobile terminal. This information, when combined with the output of the compass 110, may give a more accurate picture of the movement of the mobile terminal.

The exact implementation of the position change sensing is not essential to the understanding or operation of the invention. Other known sensing techniques or techniques which have not yet been employed may be substituted for the above described technologies.

In any case, if no movement is detected at step 304 then the mobile terminal continues to operate in “Phone mode”. If movement is detected, then a note taking application 126 is started at step 306. Starting the note taking application may comprise the operating system 124 beginning or resuming execution of the note taking application, or if the application is already running, prioritising the note taking application processes.

At step 308 the display 116 is controlled by the note taking application 126 to display a note entry form 210 as described above with reference to FIG. 2B. At step 310, it is detected whether the call has ended. Such a detection may be made by the operating system upon receiving a disconnection signal from the transceiver 106. The call may be ended upon instruction by either of the parties to the call or may be ended due to a loss of connection at either end of the cellular network. If the call has not ended, the display 116 continues to display the note entry form 210. If the call has ended, a call ended screen may be displayed at step 312 indicating to the user that the call has been terminated.

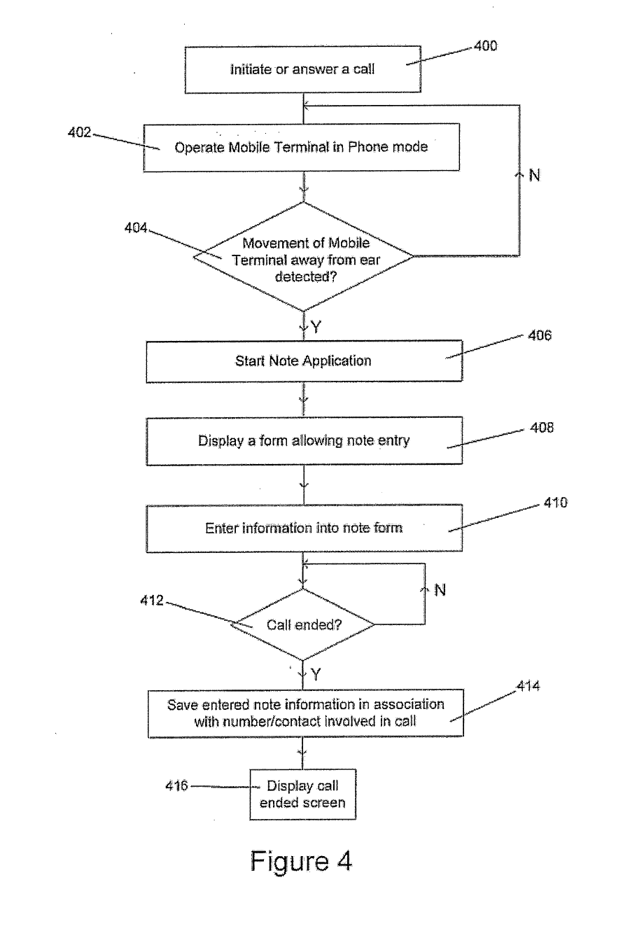

In FIG. 4, steps 400 to 408 are identical to steps 300 to 308 of FIG. 3. At step 408 a note entry form 210 is displayed. At step 410, information is entered into the form in response to user inputs. This information may be text or drawings and may be entered in any of the ways described above. At step 412 it is detected whether or not the call has ended. If the call has not ended then the display 116 continues to display the note entry form 210 containing any notes that the user has already made. The user may also continue to enter notes at this stage. If it is determined at step 412 that the call has ended, then the operating system 124 causes the entered note information to be automatically saved in the mobile terminal memory 122 at step 414. In one embodiment the entered note is saved in association with the contact 202 and/or number 204 involved in the call. The saved note may additionally be associated with some other information, for example a date entered in the note itself.

When a user wishes to retrieve the note, they may navigate on the mobile terminal 100 to the contact that participated in the call and find the note saved with that contact's other details. The user may also navigate to a list of recent calls from which any notes made during those calls can also be accessed. Additionally the memory 122 of the mobile terminal 100 may contain a dedicated note storage area where all of the user's notes can be found. If the note has been saved in association with a date entered into the note (for example, the note content 212 in FIG. 2B shows a date of 28 May 2010), then the user may retrieve the note by navigating to a calendar on the mobile terminal and selecting the date in question.

As previously described the user may manually cause a note to be saved by selecting a save note key 216 while the note entry form 210 is displayed, and may save several notes relating to a single call. Each of these notes is saved in association with the contact involved in the call and any note which is currently displayed when the call ends is auto-saved in the same manner.

At step 416 a call ended screen is displayed. Although this step is shown subsequently to step 414, the call ended screen may be displayed as soon as the call ends. The call ended screen may therefore be displayed before or during the saving of the note at step 414.

It will be appreciated that the above described embodiments are purely illustrative and are not limiting on the scope of the invention. Other variations and modifications will be apparent to persons skilled in the art upon reading the present application.

For instance, although the above describes a note taking application as being opened in response to detecting movement from an ear adjacent position to a non-ear adjacent position, the invention is applicable also to the provision of a calendar entry form, a word processing document, a drawing slate or other such form that allows user input.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A method comprising:
in response to detecting a change in position of a mobile communication device from an ear adjacent position to an ear non-adjacent position whilst the device is engaged in a call, displaying a form for allowing a user to enter a note.

2. A method according to claim 1 further comprising, in response to receiving user content inputs, displaying entered note content in the form.

3. A method according to claim 2 further comprising storing on the device the entered note content in association with a contact participating in the call.

4. A method according to claim 2 further comprising, when the call is ended, saving on the device any currently displayed note content in association with a contact which was a participant in the call.

5. A method according to claim 1 further comprising, in response to the detected change in position, executing a note taking application to provide the form.

6. A method according to claim 1 further comprising, commencing monitoring signals from one or more of a motion sensor, a positional sensor and an orientation sensor when the device engages in a call.

7. A method according to claim 1, comprising using a proximity sensor to detect the change in position.

8. A method according to claim 1, further comprising responding to the change in position by enabling a speaker mode of the device.

9. Apparatus, the apparatus being configured to detect a change in position of a mobile communication device from an ear adjacent position to an ear non-adjacent position whilst the device is engaged in a call, and in response to said detection to cause a form for allowing a user to enter a note to be displayed.

10. Apparatus according to claim 9, further configured, in response to receiving user content inputs, to cause entered note content to be displayed in the form.

11. Apparatus according to claim 10, further configured to store on the device the entered note content in association with a contact participating in the call.

12. A method according to claim 10, further configured, when the call is ended, to save on the device any currently displayed note content in association with a contact which was a participant in the call.

13. Apparatus according to claim 9, further configured, in response to the detected change in position, to execute a note taking application stored on the device in order to provide the form.

14. Apparatus according to claim 9, further configured to activate one or more of a motion sensor, a positional sensor and an orientation sensor when the device engages in a call.

15. Apparatus according to claim 9, further comprising a proximity sensor configured to detect the change in position.

16. Apparatus according to claim 9, further configured to enable a speaker mode of the device in response to the change in position.

17. An apparatus comprising
at least one processor; and
at least one memory including computer program code;
the at least one memory and the computer program code configured to, with the at least one processor, cause the apparatus at least to perform:
in response to detecting a change in position of a mobile communication device from an ear adjacent position to an ear non-adjacent position whilst the device is engaged in a call, displaying a form for allowing a user to enter a note.

18. Apparatus, the apparatus comprising means for detecting a change in position of a mobile communication device from an ear adjacent position to an ear non-adjacent position whilst the device is engaged in a call, and means responsive to said detection to cause a form for allowing a user to enter a note to be displayed.

19. A computer readable medium having stored thereon instructions for causing computing apparatus to perform a method comprising:
in response to detecting a change in position of a mobile communication device from an ear adjacent position to an ear non-adjacent position whilst the device is engaged in a call, displaying a form for allowing a user to enter a note.

20. A computer program, optionally stored on a medium, comprising instructions for causing computer apparatus to perform a method as claimed in claim 1.
